(19) United States
(12) Patent Application Publication
(10) Pub. No.: US 2026/0094208 A1
(43) Pub. Date: Apr. 2, 2026

(54) SYSTEMS AND METHODS FOR REAL TIME ALLOCATIONS

(71) Applicant: PrimaryBid Limited, London (GB)

(72) Inventors: Gavin David Sutton, London (GB); Andrew James Turner, Buckinghamshire (GB); Salil Shree Pandit, London (GB); Ian Anthony Harris, Watford (GB); Jonathan David Brian Dungay, London (GB); Andrew Ryan Brennan, London (GB)

(21) Appl. No.: 18/904,597

(22) Filed: Oct. 2, 2024

(51) Int. Cl. G06Q 40/04; G06Q 30/0601

(52) U.S. Cl. CPC G06Q 40/04; G06Q 30/0609

(57) ABSTRACT

Aspects of the disclosure provide for real time allocation for the process of issuing securities. For instance, demand for each of a plurality of participants may be identified. A set of preferences including a weight for each of a plurality of groups of the participants may be identified. A time limit to complete a grid search may be identified. The grid search may be conducted using the time limit in order to determine weights for an allocation for the participants based on the set of preferences. An allocation for each participant may be generated based on the demand for that participant and the determined weights. The allocations may be provided for display to a user.

### BACKGROUND

Various systems may offer users the ability to participate in deals involving the sale of securities such as initial public offerings (IPOs), placements (e.g., private offerings, new public share issuances, etc.), secondary offerings, fixed income products (e.g., bonds), etc. Such users may include issuers (e.g. the companies issuing securities pursuant to the deals), and customers who are purchasing the offered securities. Allocation may identify how securities may be distributed across investors (e.g., users or participants) before and after a deal has closed. Typical approaches may involve complex spreadsheets and can be a slow process.

### BRIEF SUMMARY

Aspects of the disclosure provide a method. The method includes identifying, by one or more processors, demand for each of a plurality of participants; identifying, by the one or more processors, a set of preferences including a weight for each of a plurality of groups of the participants; identifying, by the one or more processors, a time limit to complete a grid search; conducting, by the one or more processors, the grid search using the time limit in order to determine weights for an allocation for the participants based on the set of preferences; generating, by the one or more processors, an allocation for each participant based on the demand for that participant and the determined weights; and providing, by the one or more processors, the allocations for display to a user.

In one example, the set of preferences includes a guaranteed minimum for at least one of the plurality of groups of participants. In this example, when an allocation that falls within a tolerance value of one or more initial weights is not found, automatically adjusting the guaranteed minimum, and conducting a second grid search to determine the determined weights based on the adjusted guaranteed minimum. In another example, the set of preferences includes a maximum cap for at least one of the plurality of groups of participants. In this example, when an allocation that falls within a tolerance value of one or more initial weights is not found, automatically adjusting the maximum cap, and conducting a second grid search to determine the determined weights based on the adjusted maximum cap. In another example, the method also includes determining whether a total of the demand for each of the participants is greater than a number of securities to be allocated, and the grid search is conducted based on the determination. In another example, the method also includes determining a number of solutions for the grid search based on the time limit and wherein the grid search is conducted further based on the number of solutions. In this example, the method also includes determining, based on the determined weights for groups of participants, a number of dimensions for the grid search, and the number of solutions is further determined based on the number of dimensions. In another example, the method also includes determining based on the weights for groups of participants a number of dimensions for the grid search and determining a granularity for the grid search using a sensitivity analysis using a sample search in each dimension, wherein the grid search is conducted further based on the determined granularity. In this example, the grid search is conducted such that the determined granularity is symmetric in each dimension. In addition, or alternatively, the method also includes, when an allocation that falls within a tolerance value of one or more initial weights is not found, automatically adjusting a granularity of the grid search and conducting a second grid search to determine the determined weights based on the adjusted granularity. In this example, the grid search is conducted such that the determined granularity is not symmetric in each dimension. In another example, the method also includes determining a number of unallocated securities based on the allocation and a number of securities to be allocated, and wherein the number of unallocated securities is provided for display with the allocation. In another example, the method also includes providing the determined weights for display with the allocations. In another example, when an allocation that falls within a tolerance value of one or more initial weights is not found, automatically adjusting the time limit for the grid search, and conducting a second grid search to determine the determined weights. In another example, the method also includes, when an allocation that falls within a tolerance value of one or more initial weights is not found, automatically adjusting a number of securities to be allocated, and conducting a second grid search to determine the determined weights based on the adjusted number of securities to be allocated. In another example, the method also includes, when an allocation that falls within a tolerance value of one or more initial weights is not found, automatically adjusting a granularity of the grid search, and conducting a second grid search to determine the determined weights based on the adjusted granularity.

Another aspect of the disclosure provides a system comprising one or more processors. The one or more processors are configured to identify demand for each of a plurality of participants; identify a set of preferences including a weight for each of a plurality of groups of the participants; identify a time limit to complete a grid search; conduct the grid search using the time limit in order to determine weights for an allocation for the participants based on the set of preferences; generate an allocation for each participant based on the demand for that participant and the determined weights; and provide the allocations for display to a user.

In one example, the one or more processors are further configured to determine, based on the determined weights for groups of participants, a number of dimensions for the grid search and determine a granularity for the grid search using a sensitivity analysis using a sample search in each dimension. In this example, the grid search is conducted further based on the determined granularity. In another example, the one or more processors are further configured to, when an allocation that falls within a tolerance value of one or more initial weights is not found, automatically adjust a granularity of the grid search, and conduct a second grid search to determine the determined weights based on the adjusted granularity.

### BRIEF DESCRIPTION OF THE DRAWINGS

FIG. 1 is a pictorial diagram of an example system in accordance with aspects of the disclosure.

FIG. 2 is a functional diagram of the system of FIG. 1 in accordance with aspects of the disclosure.

FIG. 3 is an example user interface in accordance with aspects of the disclosure.

FIG. 4 is an example table in accordance with aspects of the disclosure.

FIG. 5 is an example two-dimensional coordinate plot in accordance with aspects of the disclosure.

FIG. 6 is an example two-dimensional coordinate plot and grid in accordance with aspects of the disclosure.

FIG. 7 is an example three-dimensional coordinate plot in accordance with aspects of the disclosure.

FIG. 8 is an example user interface in accordance with aspects of the disclosure.

FIG. 9 is an example user interface in accordance with aspects of the disclosure.

FIG. 10 is an example line by line allocation in accordance with aspects of the disclosure.

FIG. 11 is an example user interface in accordance with aspects of the disclosure.

FIG. 12 is an example two-dimensional coordinate plot and grid in accordance with aspects of the disclosure.

FIG. 13 is an example two-dimensional coordinate plot and grid in accordance with aspects of the disclosure.

FIG. 14 is an example two-dimensional coordinate plot and grid in accordance with aspects of the disclosure.

FIG. 15 is an example flow diagram in accordance with aspects of the disclosure.

### DETAILED DESCRIPTION

### Overview

The technology relates to real time allocation for the process of issuing securities (e.g., a deal), such as at an initial public offering (IPO), placement (e.g., private offering), secondary offering, fixed income products (e.g., bonds), etc. The process by which participants' demand is captured is known as a bookbuild. Allocation may identify how securities (e.g., shares, denominations of bonds, treasury bills, etc.) may be distributed across investors (e.g., users or participants) before and after a deal has closed. Typical approaches may involve complex spreadsheets and can be a slow process.

For instance, in a given bookbuild with some number of participants N, each participant submits an amount of demand for securities. The sum of each of these participant's “demand” (e.g. how many shares or dollar value requested) is the total demand D for securities. This total demand D may be represented by:

$$D = {\sum }_{i = I}^{N} {d}_{i}$$

In this example, dᵢ represents the demand from the i^{th} investor, where i=1, 2, 3, . . . . N. Thus, N may represent the total number of participants.

In many instances, the total demand D may exceed the supply of securities available S. Additionally, the amount of demand may not always divide into a whole number of shares. If either or both are the case, an allocation process must be run. The purpose of the allocation process is to find, for each investor, an allocated amount a, such that the sum of the allocated amounts is less than or equal to the supply of securities available S. Thus the goal of allocation is to map each demand to an allocated amount, where each allocation to each participant is less than or equal to that user's demand, or rather, a≤d. Additionally, each allocated amount a must, in general, represent a whole number of securities. In this regard, an allocation A, denoting the sum of all a allocated securities, may be represented by:

$$A = {\sum }_{i = I}^{N} {a}_{i} \leq S$$

In this example, aᵢ represents the allocation of shares for the i^{th} investor. Allocation therefore is the process of finding a solution which maximizes the total allocated amount, A, whilst also respecting any issuer preferences for how allocations for each participant are decided.

In some instances, such as in an institutional context, the number of participants will generally be in the 10s, or 100s. In a retail context, the number of participants is significantly higher and numbers in the tens of thousands, or even millions, is not uncommon. To meet the preferences of the issuer, a solution cannot be performed one customer at a time, the book must be considered as an aggregate. In other words, all allocations are co-dependent. Any change to any allocation to a particular participant will affect all other allocations, making the problem computationally difficult. All this may add additional layers of complexity to the allocation process.

Accordingly, a significant challenge that has existed in the allocation process in the past, is the timescales on which allocation must be performed. Typically, a bookbuild will close after market hours, and shares must be allocated before morning trading. Therefore, only a few hours may be available for the process to run. The computational complexity of the process means that performing the process manually can become impossible in the timescales required.

To address these difficulties, an allocation system may automatically generate allocations of shares in real time. For instance, the allocation system may enable the allocation of significantly complex bookbuilds in a matter of seconds, so that it can be iterated on multiple times and committed well within the timeframe required.

Given the actual or estimated number of shares, actual or estimated price of each share, demand of each participant, group of each participant, and the aforementioned preferences, the allocation system may provide a line by line allocation of shares to the participants of the bookbuild. For example, the allocation may be optimized for the issuer's preference and in order to match the demand to supply of shares.

In this regard, for each deal, in addition to identifying a number of shares and a price, an issuer may also identify preferences for the allocation. For instance, a representative of the issuer may input the preferences into a user interface via a table or spreadsheet. Such preferences may define a set of instructions for a desired allocation of shares. These instructions may include guaranteed minimum allocation percentages, priorities, as well as maximum caps which may differ for different groups of participants. These preferences may be provided at any time during the bookbuild, but preferably before the close of the deal.

The groups may be mutually exclusive and collectively exhaustive such that each participant is a member of only a single group. This may result in groups of different numbers of participants who may each request (demand) different numbers of shares and thus may receive different allocations (even though they are in the same group). For example, if the issuer wants to segment participants based on certain attributes, a clustering algorithm can be used to find an appropriate grouping, based on the distribution of the participants across those attributes. Examples of different attributes may include information about the participant such as whether the participant was a previous shareholder, demographics, relationship to the issuer, etc. In this regard, a participant's group may be assigned by the issuer, selected or otherwise identified by the participant, or the allocation system may automatically assign participants to different groups based on attributes provided.

Typically an issuer will not want to treat all participants the same in the allocation process. For example, an issuer may want to prioritize one group of participants over another. As such, the participants may fall into groups which may be weighted differently in the allocation process. In this regard, an issuer may choose a set of weights, for each of these different groups as an input. Because allocating a whole number of shares is an integer programming problem, the exact weights chosen by the issuer may not always converge on a solution. Additional complexities may be introduced by having minimum and maximum caps for each group. Together, this information may be considered an allocation policy.

In the simplest case, the demand may be less than or equal to the supply. The allocation system may round each line item of demand to the nearest whole number of securities, and return that allocation on a line-by-line level. If this introduces leftover shares, the allocation system may notify a representative of the issuer, for example by displaying a notification.

If the demand is greater than supply, then the allocation system may generate an allocation according to the preferences of the issuer. This may result in two competing objectives to maintain the initial weights provided by the issuer and to maximize the number of shares allocated. To do so, the allocation system may first determine whether there are any guaranteed allocations and if so, may apply those guaranteed allocations (e.g., allocate securities) accordingly. In the situation in which guaranteed allocations are greater than supply, then this guarantee cannot be fulfilled, and the allocation system may notify a, for example by displaying a notification.

Once any guaranteed allocations are applied, the allocation system may use the inputs exactly as provided by the issuer to determine whether there is a solution. In some cases, the sum of all the individual allocations may be equal to the supply. In such instances, then the issuer preferences have been enacted exactly as provided by the issuer, and the process stops. However, in the vast majority of bookbuilds, because many securities must be allocated in whole numbers, perfect allocations according to issuer preferences may not always be feasible. In such instances, the allocation system may perform a time-based grid search in nearby weight space.

In order to perform a grid-based search, the allocation system may determine a number of solutions to be calculated as well as the density of the grid search. This number of solutions may correspond to the total number of points on the grid. This may be determined by a time requirement or time limit for the search and may be dependent upon the computing resources of the allocation system.

The granularity or density of the grid search, corresponds to how close to one another the solutions are. The density may be determined using a number of different factors related to the participants and the characteristics of the issuer's preferences. For instance, factors such as the number of participants, the distribution of demand, whether participants are limited to specific numbers of securities, the variance of demand of participants within a given group, etc. may influence the granularity of the search. Similarly, the number and complexity of groups and corresponding issuer preferences may also strongly influence the granularity of the search. In this regard, in order to determine the density of the grid search, a sensitivity analysis may be run.

Given the granularity set by the sensitivity analysis and the number of total solutions determined by time, the allocation system may perform the time-based grid search around the initial weights. For simplicity and computational efficiency, certain preferences, such as guaranteed minimums and maximum caps may be considered fixed while other preferences, such as the weights may be varied in order to find a solution. The grid may be multi-dimensional depending on the number of groups (and corresponding weights) and the grid search may be symmetrical across different dimensions. The grid search may be limited by the total number of securities being offered in the deal as well as any minimum guarantees and maximum caps. Other inputs to the search may include each participant's demand as well as each participant group.

Once the time-based grid search is complete, the allocation system may store all of the allocation results generated in a matrix, and may then scan the matrix for solutions that are optimal for the issuer. For example, solutions that include weights closest to those provided by a representative of the issuer may be identified. These may then be used to determine an allocation of securities based on the demand of each participant. In some instances, the allocation system may find a solution that is optimal for the issuer, in which case the process may stop, and the allocation results may be displayed to a representative of the issuer.

In other instances, the allocation may not find a solution that is optimal for the preferences of the issuer in this initial grid search. In other words, the allocation solutions found in the time-based grid search either do not adequately fill the allocation of securities that has been given to the retail bookbuild, or the solution found does not adequately resemble the preferences of the issuer. In other words, if none of the solutions fall within some tolerance values, which may be selected by the issuer in advance, an optimal solution may not be found. In such situations, the allocation system may automatically perform an extended grid search. This may involve changing some of the issuer's preferences, adjusting the number of available securities, and/or taking more time to complete a more comprehensive search in order to increase the probability of finding a solution.

In addition, whether or not an optimal solution has been determined for a particular allocation policy, the inputs and allocation can be saved for comparison and further review. In this regard, an issuer can compare dozens of allocation policies, based on different input preferences, selected from billions of potential options, in a matter of seconds or at most a few minutes, giving plenty of time to pick their preference between the deal closing and the markets opening.

The features described herein may provide for real time allocations of securities which maximizes the total allocatable amount, while also respecting any issuer preferences. While there may be unlimited numbers of ways to allocate such securities for a given bookbuild, the features described herein may rapidly identify and converge on an optimal solution and present the issuer with information that provides a transparent understanding of how the process has run. In addition, the allocation system can generate allocations at scale (e.g., to generate allocations for bookbuilds with tens of thousands or even millions of participants) and within very short time frames between market close and market open, above and beyond the capabilities of current institutional allocation tools. Moreover, the allocation system may enable the system to identify nearby optimal solutions when supply is greater than demand which are closest to the issuer's preferences before and after the close of a bookbuild.

### Example Systems

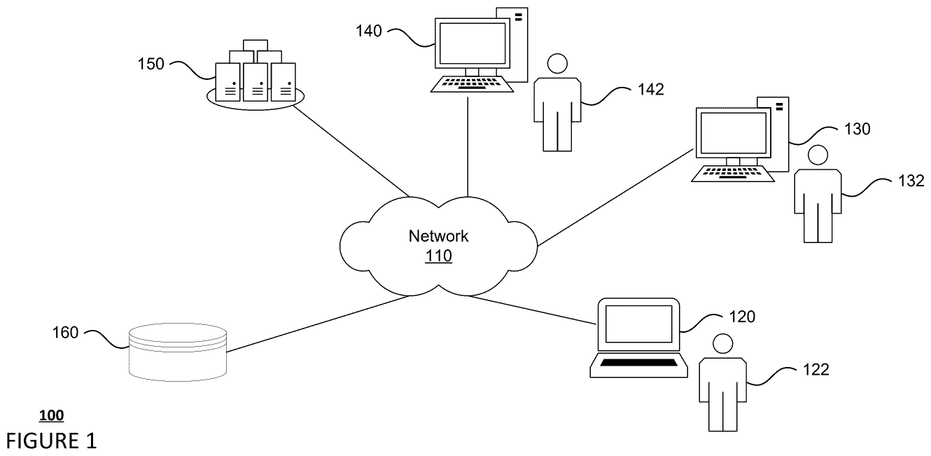

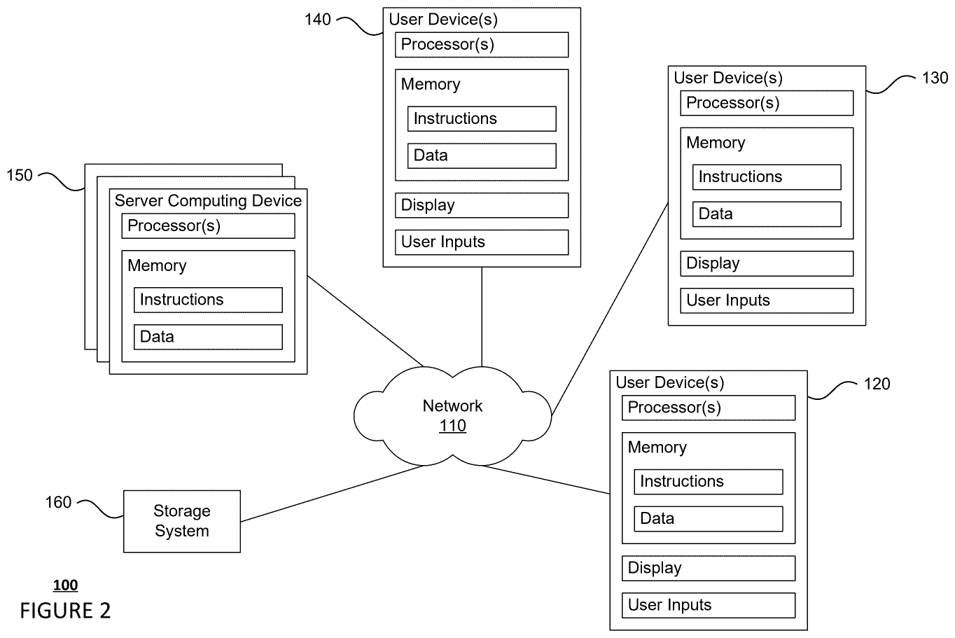

FIGS. 1 and 2 depict pictorial and functional diagrams of an example system 100 for implementing the various features described herein. As depicted, the system 100 includes a plurality of computing devices 120, 130, 140, 150 and a storage system 160 connected via a network 110. Although only a few computing devices are shown, any number of such devices may be included in the system described herein.

As shown in FIG. 2, each of the computing devices 120, 130, 140, 150 may include one or more processors, memory, data and instructions. The memory stores information accessible by the one or more processors, including instructions and data (e.g., machine translation model, parallel corpus information, feature extractors, etc.) that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing; whereby different portions of the instructions and data are stored on different types of media.

The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available central processing units (CPUs), tensor processing units (TPUs), etc. Alternatively, each processor may be a dedicated device such as an application-specific integrated circuit (ASIC) or other hardware-based processor. Although FIG. 2 functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of the computing devices 150. Accordingly, references to a processor or computing device will be understood to include references to a collection of processors or computing devices or memories that may or may not operate in parallel.

The computing devices may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users.

The computing devices 120, 130, 140 may be configured as user devices, end user devices, client computing devices, or other client devices which can communicate with a back-end computing system, such as the server computing devices 150, via one or more networks, such as network 110. As an example, computing device 120 may be a laptop while computing device 130 may be a desktop computer. Such devices may be used, for instance, to provide a person (e.g. human operators or users 122, 132, 142), with the ability to interact with other computing devices of the system. Other types of user devices, such as mobile phones, tablet PCs, smartwatches, head-mounted displays and other wearables, etc., may also be employed.

As noted above, the computing devices 150 may include one or more server computing devices having a plurality of computing devices, e.g., a load balanced server farm, that exchange information with different nodes of a network, such as network 110, for the purpose of receiving, processing and transmitting the data to and from other computing devices. For instance, the server computing devices 150 may be capable of communicating with each of the computing devices 120, 130, 140 via the network 110. The server computing devices 150 may send and receive information from the computing devices 120, 130, 140, access information from the storage system 160, and function as part of an allocation system as discussed further below. In this regard, the allocation system referred to herein may include server computing devices 150, server computing devices 150 and the storage system 160, or a combination of server computing devices 150, the storage system 160, and one or more of the computing devices 120, 130, 140.

The network 110, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

As with the memory of the computing devices 120, 130, 140, and 150, the storage system 160 can be of any type of computerized storage capable of storing information accessible by the one or more server computing devices 150, such as a hard-drive, memory card, ROM, RAM, DVD, CD-ROM, write-capable, and read-only memories. In addition, storage system 160 may include a distributed storage system where data is stored on a plurality of different storage devices which may be physically located at the same or different geographic locations. Storage system 160 may be connected to the computing devices via the network 110 and/or may be directly connected to or incorporated into any of the computing devices 120, 130, 140, 150, etc.

Storage system 160 may store various types of information as described in more detail below. This information may be retrieved or otherwise accessed by a server computing device, such as one or more server computing devices 150, in order to perform some or all of the features described herein. For instance, the storage system may receive and store information input by users (e.g., participants) such as attributes, demand, etc. as well as information input by representatives of issuers such as the number of securities available, price, preferences, etc. The storage system may also store matrices of weights as well as corresponding allocations as discussed further below.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

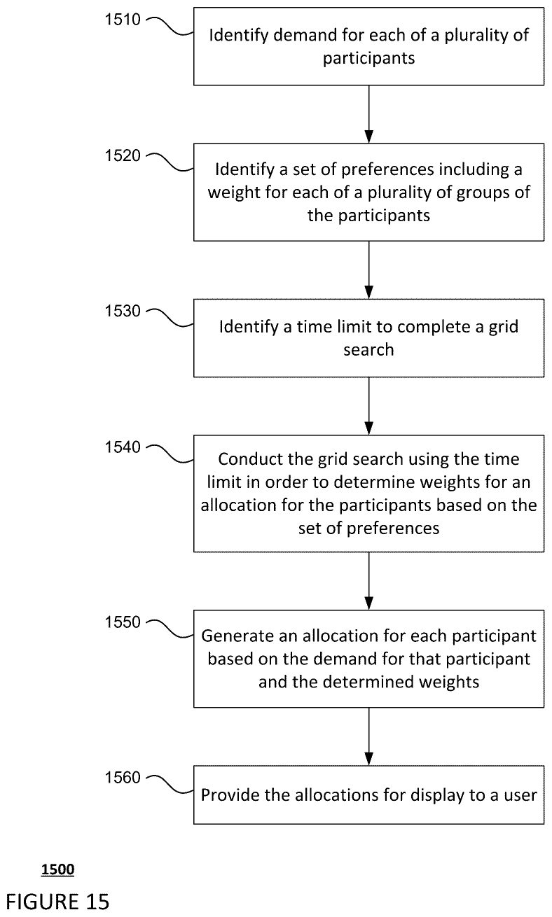

As described above, an allocation system may automatically generate allocations of securities in real time. For instance, the allocation system may enable the allocation of significantly complex bookbuilds in a matter of seconds, so that it can be iterated on multiple times and committed well within the timeframe required. FIG. 15 is an example flow diagram 1500 for generating allocations in real time which may be performed, for example, by one or more processors of the one or more server computing devices 150. At block 1510, demand for each of a plurality of participants is identified. For instance, in a given bookbuild of some number of participants, each participant submits an amount of demand for securities. The sum of each of these participant's “demand” (e.g. how many securities are requested) is the total demand for securities. For example, a participant, such as user 122, may use an application running on a client computing device, such as computing device 120, in order to input information such as the participant's desired demand (e.g., desired number of securities and/or the maximum value of securities the participant is willing to purchase). In some instances, the participants may also provide additional information, such as the attributes or the identification of a particular group to which the participant belongs as discussed further below. This information may be sent by the application to the server computing devices 150 via the network 110 and stored, for example, in the storage system 160 for later retrieval and use by the server computing devices.

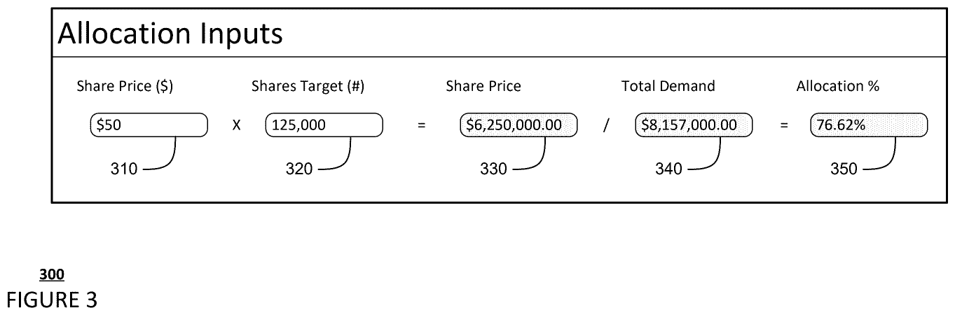

In order to determine an allocation, the representative of the issuer may input a number of securities as well as a price (either estimated before close or actual after close). Comparing this to the total demand may be used to determine what percentage of the number of available securities could be allocated. FIG. 3 is an example of a user interface 300 including fields where a representative of the issuer may input information for an allocation for a bookbuild. It will be understood that the details and information provided in this example are fictitious and merely representative of a bookbuild and not actual data.

The user interface 300 may be displayed, for example, on a display of a client computing device, such as client computing device 130. In this example, box 310 provides a field for entering an estimated or actual price per security (here, share price). Box 320 provides a field for entering a number of securities available(S), here, a share target number (“Share Target (#)”). A user, such as user 132 may enter information into these fields for a particular bookbuild. The allocation system may use the information to determine an allocation target displayed in box 330. This allocation target may represent the total potential value of a deal (here in US dollars) if all of the available shares are allocated. The allocation system may also provide a total demand value (“Total Demand”) displayed in box 340. The total demand value may represent the total potential value of a deal (here in US dollars) if all of the demand from all participants was fulfilled at the entered price per security in box 310. These values may be compared and the resulting ratio or allocation percentage is displayed in box 350. In example 300, the total demand for securities, here 163,240 shares, corresponds to a total demand value of $8,157,000.00 for shares at $50 per share. This total demand value is greater than the number of securities available, so the allocation system will only be able to allocate shares to fulfill 76.62% of the total demand (or of the total demand value).

Returning to FIG. 15, at block 1520, a set of preferences including a weight for each of a plurality of groups of the participants is identified. In this regard, for each bookbuild, an issuer may identify preferences for the allocation. For instance, the representative of the issuer may input one or more combinations of preferences into a user interface via an application of a client computing device, such as the client computing device 130. For example, the preferences may be inputted via a table or spreadsheet. In this regard, the issuer may provide a plurality of different combinations of preferences for a single deal. This may allow the issuer to review and compare allocations made under a plurality of different allocation policies. However, before using the allocation system, the representative of the issuer may select a single combination or a plurality of combinations to run for comparative purposes.

In this regard, such preferences may define a set of instructions for a desired allocation of securities. These instructions may include guaranteed minimum allocation percentages of desired demand or number of shares, priorities, as well as maximum caps on percentages of desired demand or number of securities which may differ for different groups of participants. These preferences may be provided at any time during the bookbuild, but preferably before the close of the deal (when the final allocation is determined).

The groups may be mutually exclusive and collectively exhaustive such that each participant is a member of only a single group. This may result in groups of different numbers of participants who may each request (demand) different numbers of securities and thus may receive different allocations (even though they are in the same group). Examples of different types of groups may include issuer employees, loyalty program members, company directors, existing securities holders (e.g., existing shareholders), general retail investors, brokers, previous participants, and any combination of these or other types of participants.

A participant's group may be assigned by the issuer, selected or otherwise identified by the participant (as noted above), or the allocation system may automatically assign participants to different groups based on attributes provided. For instance, if the issuer wants to segment participants based on certain attributes, a clustering algorithm can be used to find an appropriate grouping, based on the distribution of the participants across those attributes. Examples of different attributes may include information about the participant such as whether the participant was a previous shareholder, demographics (e.g., location, age, etc.), relationship to the issuer (e.g., employee and for how long, executive and for how long, customer and for how long and/or past spend with the issuer, etc.), etc. Again, as noted above, these attributes may be provided by the participants and verified by the issuer and/or provided by the issuer.

In some instances, a machine-learning model may be used to determine an appropriate grouping. As an example, if an issuer has something like “spend in the last 12 months” as an attribute, participants may be divided by an unsupervised machine learning model into different groups (e.g., low spend, medium spend, high spend). In this regard, when determining the groups, the machine learning model may also take into account numerous other attributes at once in order to form different groups and adjust participants in and out of those groups as additional participants and/or as participant demands are input or adjusted.

Typically an issuer will not want to treat all participants the same in the allocation process. For example, an issuer may want to prioritize one group of participants over another. As such, the participants may fall into groups which may be weighted differently in the allocation process. In this regard, an issuer may choose a set of weights, for each of these different groups as an input. Because allocation is a discrete, integer programming problem, the exact weights chosen by the issuer may not always converge on a solution. Additional complexities may be introduced by having minimum and maximum caps for each group. Together, this information may be considered an allocation policy.

As an example, the N participants described above may be grouped into K number of groups, group 1, group 2, group 3, . . . group K. The actual number of groups may depend upon the desires and/or circumstances of the issuer and may range from 2 groups to 9 or more groups. The issuer may also provide a weight w; for each of these groups, where j=1, 2, 3, . . . . K. Thus, individual groups may be weighted the same or differently in the allocation process depending upon the preferences of the issuer.

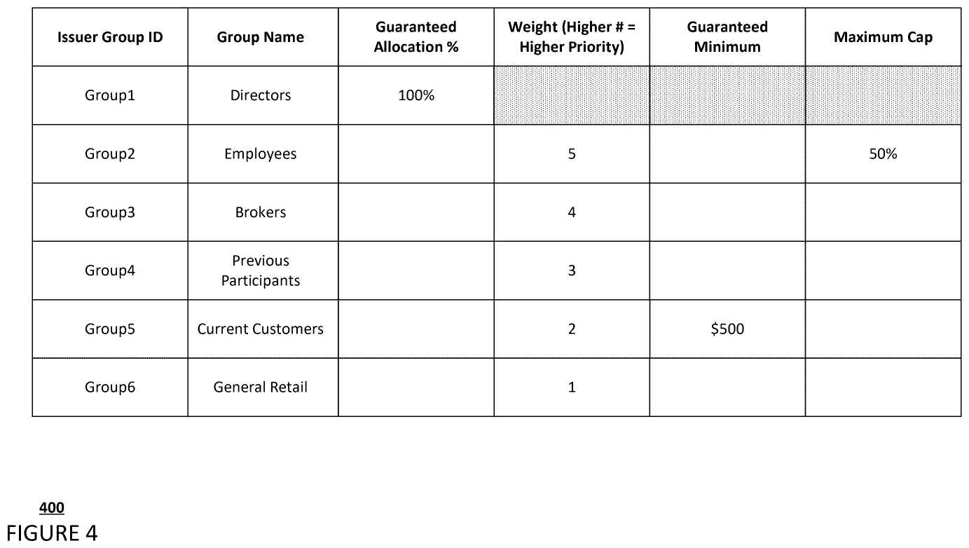

FIG. 4 depicts a representative table 400 of example groups and corresponding set of preferences for a fictitious deal. This table may enable a representative of the issuer to input information, including the issuer's desired groups for a deal. In this example, the groups include “Directors” which may include participants who are directors of the issue, and Employees” which may include participants who are employees of the issuer, “Brokers” which may include participants that are securities brokers (e.g., typical brokers who connect buyers and sellers of securities), “Previous Participants” which may include participants which have previously participated in deals by the issuer, “Current Customers” (e.g., customers of the issuer in the last year or two years, etc.), and “General Retail” which may include participants who do not fall into any other groups. Of course, fewer or greater numbers of groups and/or any number of different types of groups may be used.

FIG. 4 also provides example weights w for each of the groups identified by the issuer. In this example, the weights represent the issuer's priorities or which groups should receive allocations over which other groups, with higher values indicating a higher priority. For example, employees (w_{Group2}=5) may receive allocations preferentially over brokers, brokers (w_{Group3}=4) may receive allocations over previous participants, previous participants (w_{Group4}=3) may receive allocations preferentially over current customers, and current customers (w_{Group5}=2) may receive allocations preferentially over general retail participants (w_{Group6}=1).

In some instances, certain groups may be assigned a guaranteed allocation percentage. In this example, directors are guaranteed a 100% allocation for their demand. In such instances, these participants (those with 100% guaranteed allocation designations) need not also be given a weight. Similarly, some groups may be assigned a guaranteed allocation minimum or maximum which may be defined as a number of securities (e.g., a fixed number of shares). In this example, employees are limited to a maximum of 50% of their demand (but could potentially receive a lesser allocation), and current customers are guaranteed at least $500 of their demand (but could potentially receive a greater allocation). As can be seen, the combinations of user preferences can quickly become incredibly complex even with only a small number of groups.

The set of weights, w_{Group1}, w_{Group2}, w_{Group3}, . . . . w_{GroupK}, for each of these different groups may therefore be used as an input to the allocation system which attempts to minimize:

$${\sum }_{j = I}^{K} \vert {w}_{j} - {w}_{j}^{*} \vert$$

In this example,

$${w}_{j}^{*}$$

represents the weight (or weights) determined by the allocation system for each group. At the same time, the allocation system may also attempt to minimize the difference between the number of securities available and the total allocation, or rather, to minimize S−A while also ensuring that the total allocation is less than or equal to the number of securities available, or rather so that A≤S. Again, as noted above, additional complexities may be introduced by having minimum and maximum caps for each group.

In the simplest case, the total demand D may be less than or equal to the supply or the number of securities available S, or D≤S. In such instances, the allocation system may round each line item of demand to the nearest whole number of securities, and return that allocation on a line-by-line level. If this introduces leftover securities, the allocation system may notify the issuer, for example by displaying a notification to a representative of the issuer.

If the demand is greater than supply, or D>S, then a scale back needs to occur. In this regard, the allocation system may generate an allocation according to the preferences of the issuer. This may result in two competing objectives to maintain the initial weights provided by the issuer and to maximize the number of securities allocated. To do so, the allocation system may first determine whether there are any guaranteed allocations and if so, may apply those guaranteed allocations (e.g., allocate securities) accordingly. In the rare situation in which guaranteed allocations are greater than supply, then this guarantee cannot be fulfilled, and the allocation system may notify the issuer, for example by displaying a notification to the issuer.

Once any guaranteed allocations (e.g., guaranteed percentages, guaranteed minimum, and maximum caps) are applied, the allocation system may use the inputs and issuer preferences exactly as provided by the issuer to determine whether there is a solution. In some, rare instances, the sum of all of the individual allocations may be equal to the number of available securities, or S=A. In such instances, then the issuer preferences, or all of the guaranteed percentages, guaranteed minimum, maximum caps, and the weights, have been enacted exactly as provided by the issuer, and the process stops. In other instances, the allocation system may perform a time-based grid search.

Returning to FIG. 15, at block 1530, a time limit to complete a grid search is identified. As noted above, in the vast majority of deals, because securities must be allocated in whole numbers, perfect allocations according to issuer preferences may not always be feasible. In such instances, because allocation is a discrete, integer programming problem, the allocation system may perform a time-based grid search in nearby weight space (e.g., in order to find a solution that is close to the weights provided by the representative of the issuer).

In order to perform a grid-based search, the allocation system may determine a number of solutions to be calculated as well as the density of the grid search. This number of solutions may correspond to the total number of points on the grid. This may be determined by a time requirement or time limit for the search and may be dependent upon the computing resources of the allocation system. For example, in order to return results in near real-time (e.g., 3 seconds or less), the allocation system may determine how many computations it can perform in that time limit. Given the number of dimensions n for the search (e.g., the number of different weights to be considered), the n^{th} root of the maximum number of calculations may be determined. This may then be used to limit the number of searches in the grid or rather, the number of solutions. A typical search may have 2, 3, 4, 5, or more dimensions but again will be defined by the number of weights provided by the representative of the issuer.

The granularity, or density of the grid search, may correspond to how close to one another the solutions are. The density may be determined using a number of different factors related to the participants and the characteristics of the issuer's preferences. For instance, factors such as the number of participants, the distribution of demand (e.g., different participants may request different number of securities), whether participants are limited to specific numbers of securities (e.g., 10, 100, 1000, 2000, etc.), the variance of demand of participants within a given group, etc. may strongly influence the granularity of the search. For example, the more varied the distribution of demand for each group, the greater the granularity of the search may be required.

Similarly, the number and complexity of groups and corresponding issuer preferences may also strongly influence the granularity of the search. For example, the more groups and corresponding weights the issuer chooses, the more dimensions there are for the search, which may also impact the granularity of the search. In other words, for some bookbuilds, there will be solutions that meet the issuer's preferences very close to the issuer's exact weights and/or other preferences. In other cases, a sparser search for solutions that are further away from the initial solution may be required. The range of the search, or how far away from the issuer's initial preferences that the search will look, may be determined by the density of the grid and the total number of solutions sought in the search.

In this regard, in order to determine the density of the grid search, a sensitivity analysis may be run. For example, a sample search of some number of points, such as 10, 50, 100 or more or less, in each dimension may be made. This may help the allocation system to assess the level of unique allocation solutions in the sample search and to eliminate orders of magnitude that are too small (e.g., where there are very few unique solutions) or too large (e.g. where every solution in the grid is different to every other). As an example, the granularity may be set as the order of magnitude where there are just fewer than some desired number of unique allocations (e.g., 10, 25, 50, 100 or more or less) in each dimension.

Returning to block 1540, the grid search is conducted using the time limit in order to determine weights for an allocation for the participants based on the set of preferences. Given the granularity set by the sensitivity analysis and the number of total solutions determined by time, the allocation system may perform the time-based grid search around the initial weights. For simplicity and computational efficiency, certain preferences, such as guaranteed minimums and maximum caps may be considered fixed while other preferences, such as the weights may be varied in order to find a solution. The grid may be multi-dimensional depending on the number of different groups (and corresponding weights) and the grid search may be symmetrical across different directions. In other words, the granularity of the grid may be uniform in each dimension. The grid search may be limited by the total number of securities being offered in the deal as well as any minimum guarantees and maximum caps. Other inputs to the search may include each participant's demand as well as each participant group.

As a simple example for illustrative purposes, an issuer may identify two groups for a deal. These two groups may include “Group A” and “Group B”. For example, Group A may include all other participants, and Group B may include participants who are current shareholders. As another example, Group A may include directors and employees, and Group B may include all other participants. Of course, Group A and Group B may represent any number of different types of participants.

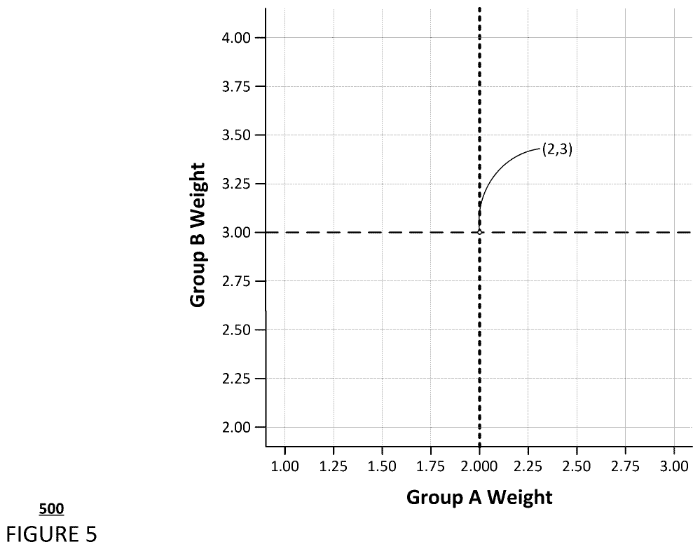

The issuer may identify a price and a number of available securities as noted above. In addition, the issuer may identify weights for each of the groups. Using the example above, the issuer may assign a weight (w_{GroupA}) of 2 to Group A and a weight (w_{GroupB}) of 3 to Group B. FIG. 5 depicts an example two-dimensional coordinate plot 500 depicting the relationship (dashed-lines) between the weights for Group A and Group B in two-dimensional weight space. In this example, the allocation system may attempt to prioritize Group A as close to 2:3 to Group B as possible while also minimizing S-A and ensuring that A≤S.

A time-based grid search may be conducted around the issuer's preferences or rather, the aforementioned weights. The allocation system may interpolate to trial combinations of coordinates within a grid around the issuer's preferences. As noted above, a sensitivity analysis may be used to set the density of the grid, and the time limit would set a total number of searches within the box.

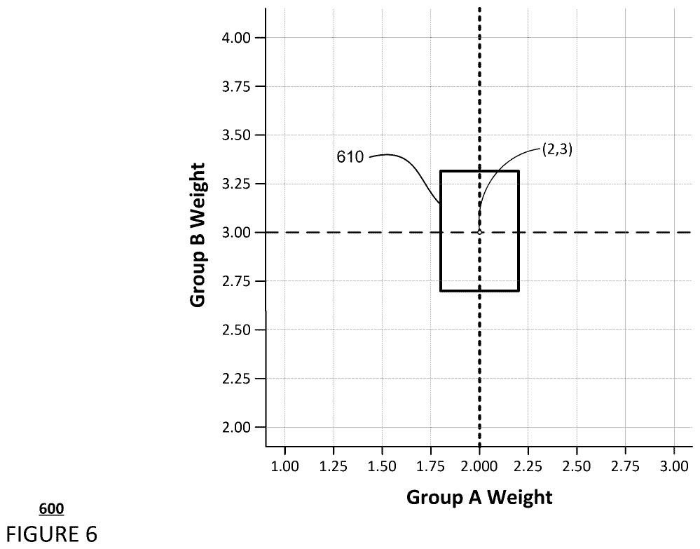

The product of the density and the number of searches may be used to define the total grid size. Continuing from the examples of FIGS. 4 and 5, if there are 10,000 searches at 0.001% granularity, this combination would result in a search that was 10% above and below the initial weights as depicted in the example two-dimensional coordinate plot 600 of FIG. 6 (corresponding to plot 500 of FIG. 5). In the example of FIG. 6, box 610 is arranged around the coordinates defining the bounds of the grid search as 10% above (e.g., 2.2 and 3.3) and below (e.g., 1.8 and 2.7) the issuer's preferences (w_{GroupA}=2, w_{GroupB}=3).

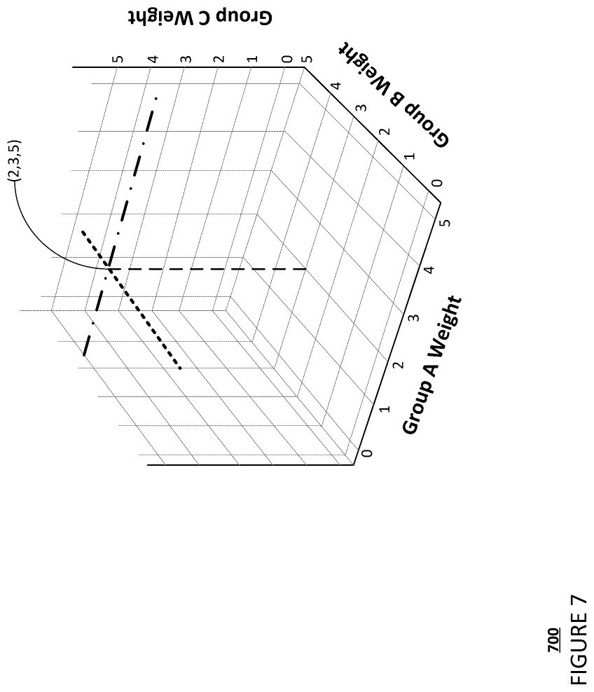

Although the example above with Group A and Group B is a simplified one, the searches may become more and more complex as additional groups (and weights) are added. FIG. 7 is an example three-dimensional coordinate plot 700 of FIG. 7. This example adds just one additional group, Group C, to the example of FIGS. 5 and 6 above with a weight (w_{GroupC}) of 5, but as can be seen, this results in a three-dimensional weight space and, as a result, a more complex search.

Returning to FIG. 15, at block 1550, an allocation for each participant is generated based on the demand for that participant and the determined weights. Once the time-based grid search is complete, the allocation system may store all of the allocation results generated in a matrix, and may then scan the matrix for solutions that are optimal for the issuer. For example, solutions that include weights closest to those provided by the representative of the issuer may be identified. These may then be used to determine an allocation of securities based on the demand of each participant. For example, for each solution found, an allocation may be determined. In many instances, the allocation system may determine numerous (thousands, tens of thousands or even millions of different allocations). These may then be analyzed to see which solutions result in an optimal allocation with the fewest number of securities unallocated and for which the determined weights are closest to the initial weights provided by the issuer. In this regard, a user can generate millions of solutions and get back one or more allocations (e.g., the top 3 optimal allocations) in a matter of seconds.

Returning to FIG. 15, at block 1560, the allocations are provided for display to a user. In some instances, the allocation system may find a solution, for example a set of weights for each group, that is optimal for the issuer. In such instances, the process may stop, and the allocation results may be displayed to the representative of the issuer. This may also include information such as a summary of the actual weights used, initial weights (e.g., the issuer's preferences) as well as how close to the number of securities the allocation is (e.g., S−A, etc.). This may provide feedback to the representative of the issuer as to whether the issuer preferences were able to be met exactly, or whether a ‘nearby’ solution has been found.

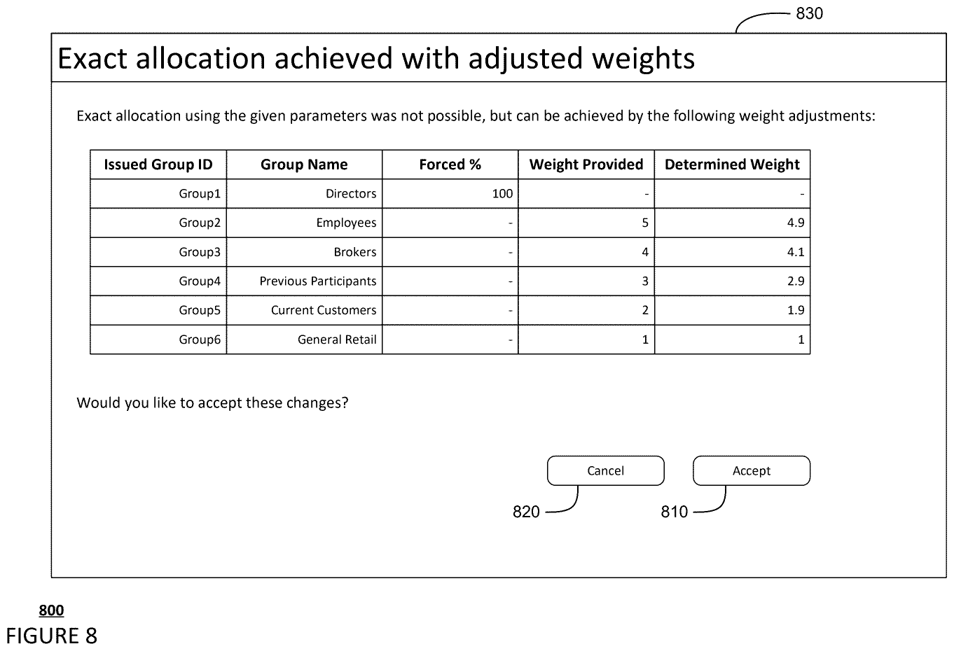

For example, FIG. 8 is an example user interface 800 for displaying the weights resulting from a search to a user. The user interface 800 may be displayed, for example, on a display of a client computing device, such as client computing device 130. This example uses the same groups, guarantees, and weights as user interface 300 of FIG. 3. In this example, the user interface 800 includes a notification 830 indicating that an exact allocation was found with adjusted weights. The user interface 800 identifies the issuer's groups for the deal, weights for each of these groups, as well as the 100% guaranteed allocation to directors. The results of the search provide a set of determined weights for each of the groups. In this example, the weights for employees, previous participants and current customers are decreased (w_{Group2}=5→4.9, w_{Group4}=3→2.9, w_{Group5}=2→1.9), while the weight for brokers is increased (w_{Group3}=4→4.1), and the weight for general retail remains the same (w_{Group6}=1→1). In this example, the representative of the issuer is also provided with selectable options, including an option 810 to accept the allocation and an option 820 to cancel.

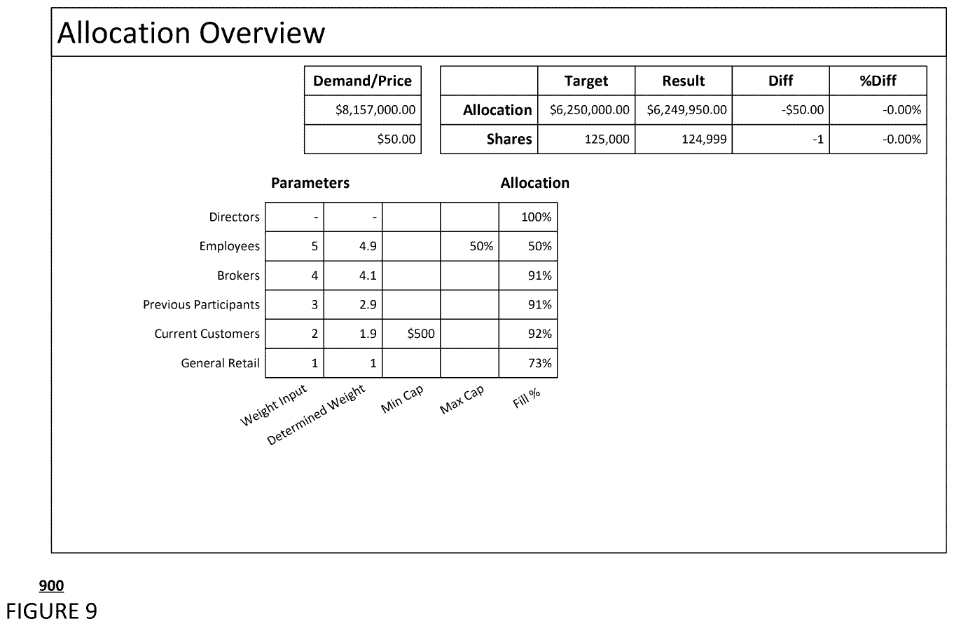

In some instances, the issuer may be provided with additional details about the results of an allocation using the determined weights. For example, FIG. 9 is another example user interface 900 for displaying an allocation to a user. The user interface 900 may be displayed, for example, on a display of a client computing device, such as client computing device 130. This example uses the same groups, guarantees and caps, and weights as table 400 of FIG. 4 using the details of the bookbuild from user interface 300 of FIG. 3. In addition to these details, user interface 900 includes the adjusted weights from user interface 800 and provides additional information about the results of allocation using the set of determined weights. For example, user interface 900 provides a resulting allocation value of $6,249,950.00 based on an allocation of 124,999 shares using the set of determined weights. User interface 900 also provides information about the difference (“Diff”) in the Allocation Target (−$50.00) and share target number (−1 share) as well as corresponding ratios, here represented by “% Diff”. Since the differences are so small, the corresponding ratios are close to zero. User interface 900 also provides a “Fill %” value for each group based on the determined weights. This value represents a percentage of demand that each participant in a group can expect to receive for the allocation. In this regard, directors would receive 100% of their demand, while employees would receive 50% of their demand, brokers and previous participants would receive 91% of their demand, current customers would receive 92% of their demand, and general retail would receive 73% of their demand. Put differently, for every $1 of demand, a participant in the director group could expect to receive approximately $1 worth of securities in the deal. Similarly, for every $1 of demand, a participant in the employee group could expect to receive approximately $0.50 worth of securities in the deal. As a further example, for every $1 of demand, a participant in the current customers group could expect to receive approximately $0.92 worth of securities in the deal, and so on.

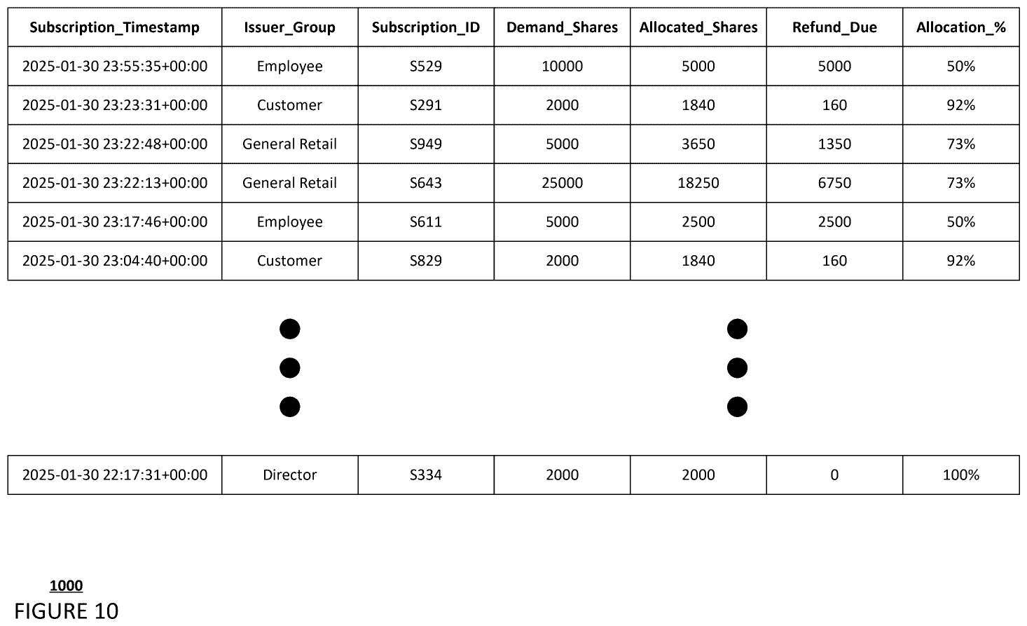

The allocation results may also include a line by line list of demand for each participant as well as an allocation of securities to each participant. FIG. 10 is an example line by line allocation 1000 of securities for the allocation represented in FIG. 9. Although only a few participants are displayed for simplicity, the ellipses represent any number of additional participants in the bookbuild or deal. In this example, individual participants are listed by identifiers (“Subscription_ID”) as well as their respective groups (“Issuer_Group”) and a timestamp (“Subscription_Timestamp”) when that participant's demand was included in the bookbuild. The line by line list of demand also includes the shares requested by each participant (“Demand_Shares”) as well as the number of shares allocated (“Allocated_Shares”) to that participant and the corresponding ratio of demand to allocation (“Allocation %”). In this example, the issuer is also provided with information identifying how much of a refund each participant is due (“Refund_Due”).

As an example, the participant with identifier S529 is included in the employee group, requested 10,000 shares, and would receive 5,000 shares in the allocation. In this regard, the participant with identifier S529 would receive 50% of their desired demand and would be due a refund of $5,000. As another example, the participant with identifier S643 is included in the general retail group, requested 25,000 shares, and would receive 28,250 shares in the allocation. In this regard, the participant with identifier S643 would receive 73% of their desired demand and would be due a refund of $6,750. As yet another example, the participant with identifier S334 is included in the director group, requested 2,000 shares, and would receive 2,000 shares in the allocation. In this regard, the participant with identifier S334 would receive 100% of their desired demand and would be due a refund of $0 (e.g., no refund).

The issuer (or representative of the issuer) can accept (e.g., and publish) the allocation results, or return to try a new search with new preferences or numbers of securities. For example, returning to FIG. 8, the representative of the issuer may select option 810 to accept the allocation. Alternatively, the representative of the issuer may select option 820 to cancel in order to return to try a new search with new preferences or numbers of securities. This may be particularly useful where the bookbuild has not yet closed and the inputs are estimates.

In other instances, the allocation may not find a solution that is optimal for the preferences of the issuer in this initial grid search. In other words, the allocation solutions found in the time-based grid search either do not adequately fill the allocation of securities that has been given to the retail bookbuild, or the solution found does not adequately resemble the preferences of the issuer. In other words, if none of the solutions fall within some tolerance values, which may be selected by the issuer in advance, of the initial weights, an optimal solution may not be found. For example, if 0.5%, 1%, 5%, 10%, 20% or more or less of the securities are not allocated or if the determined weights are greater than 10%, 20% or more or less different from the initial weights, there may be no optimal solution found.

In such situations, the allocation system may automatically perform a subsequent or extended grid search. This may involve changing some of the issuer's preferences (e.g., guaranteed minimums and maximum caps), adjusting the number of available securities, and/or taking more time to complete a more comprehensive search in order to increase the probability of finding a solution. In many instances, the issuer may provide this information (e.g., approval for certain approaches) in advance in order to maintain the speed and efficiency of the allocation process. Such searches may be configured and conducted as described above.

As noted above, the issuer may allow the allocation system to make minor adjustments to the guaranteed minimums and maximum caps in order to find nearby optimal solutions. However, this may result in a significantly more complex and time-consuming search.

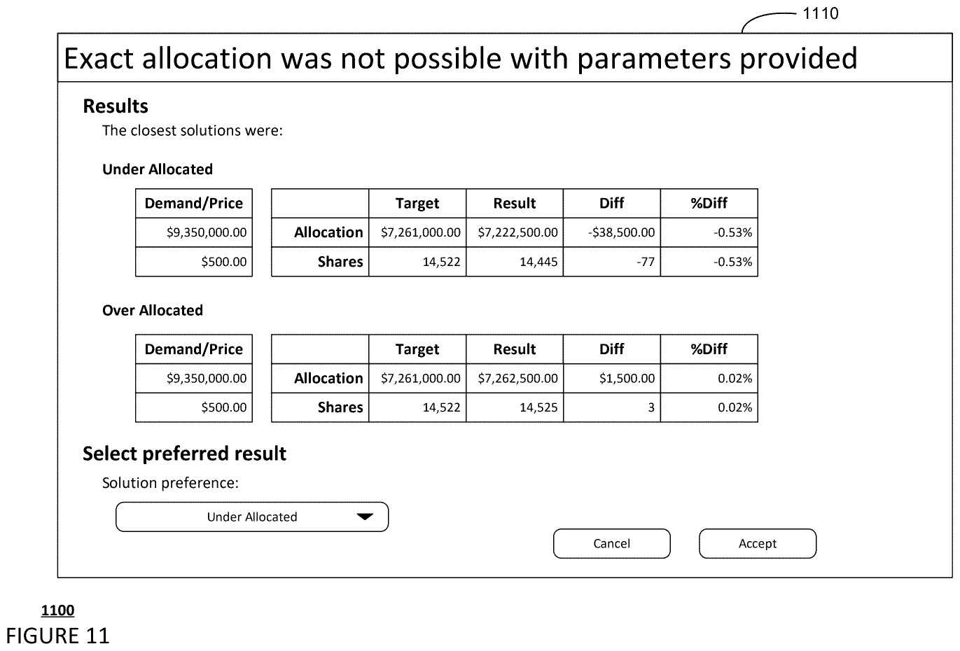

In addition or alternatively, the issuer may allow the allocation system to adjust the number of securities (increase and/or decrease) in order to find a more optimal allocation. FIG. 11 is an example user interface 1100 in which a representative of the issuer is provided with a notification 1110 indicating that an exact allocation was not possible with a set of parameters provided. In this example, the total demand value for a bookbuild is $9,350,000.00 for securities (here, shares) offered at a share price of $500.00. As the target number of shares is 14,522, the allocation target is $7,261,000.00, which is less than the total demand value. After conducting a search for weights as described in the examples above, in this example, the allocation system has provided an allocation in which the target number of shares was not reached (“Under Allocated”) with a difference of −0.53% or 77 unallocated shares. In this example, this allocation does not meet the issuer's desired tolerance value or values. As a result, the allocation system may attempt to conduct additional searches with the issuer's set of preferences which incrementally increase and/or decrease the target number of shares (e.g., by 1 share, 5 shares, 10 shares, 100 shares, or more or less) until a solution is found which does meet the issuer's desired tolerance value or values. As depicted in FIG. 11, a nearby solution has been found (“Over Allocated”) which would result in a difference of only 3 shares from the target number of shares. Conducting such additional searches and providing this information may allow the issuer (or the representative of the issuer) to identify how very small changes to the number of available shares may result in a significantly better outcome for the issuer. For example, the corresponding ratio for the difference would increase from −0.53% if under allocated by 77 shares to 0.02% if an additional 3 shares are made available. In this particular example, the issuer may receive an increase in investment of $40,000.00 ($38,500.00+$1500.00) by allowing only 3 additional shares to be allocated at $500.00 each.

In addition or alternatively, the allocation system may adjust the time limit for the subsequent grid search. As an example, the time limit for a subsequent search may be increased by a factor of 2 or 3 or exponentially. For example, if the initial search is 3 seconds, a subsequent search may be 6 seconds (factor of 2) or 30 seconds (factor of 10), and any additional searches thereafter may be increased to 12 seconds (e.g., 6×2) or even 300 seconds (e.g., 30×10), etc. Of course, other values and approaches may also be used.

Increasing the amount of time to conduct the grid search may be particularly helpful where the issuer has inputted a greater number of preferences (e.g., greater dimensions for the search), as increasing the number of dimensions may result in an exponential decay in the number of searches in each dimension. In this regard, increasing the amount of time may increase the number of searches that can be conducted. Increasing the amount of time may therefore allow for a more granular grid search or the bounds of the grid search.

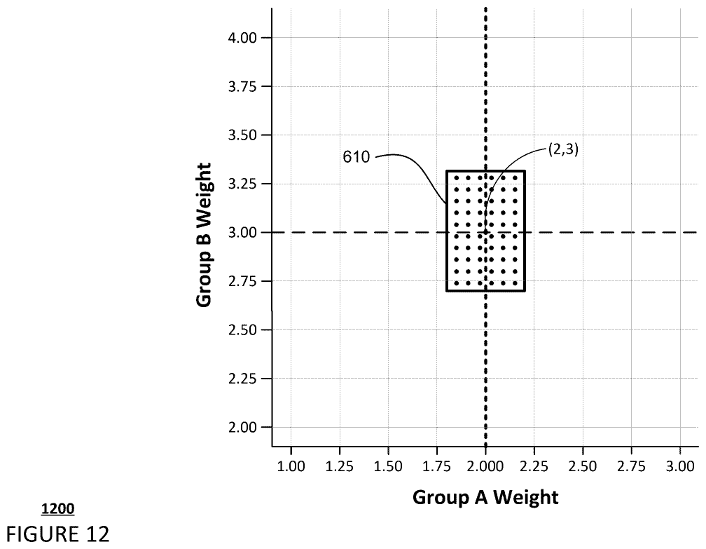

For example, FIG. 12 is an example two-dimensional coordinate plot 1200 which generally corresponds to the example two-dimensional coordinate plot 600 of FIG. 6. In the example, as with the example of FIG. 6, box 610 is arranged around the coordinates defining the bounds of the grid search as 10% above (e.g., 2.2 and 3.3) and below (e.g., 1.8 and 2.7) the issuer's preferences (w_{GroupA}=2, w_{GroupB}=3. The dots within the bounds of the grid represent the granularity of the grid search.

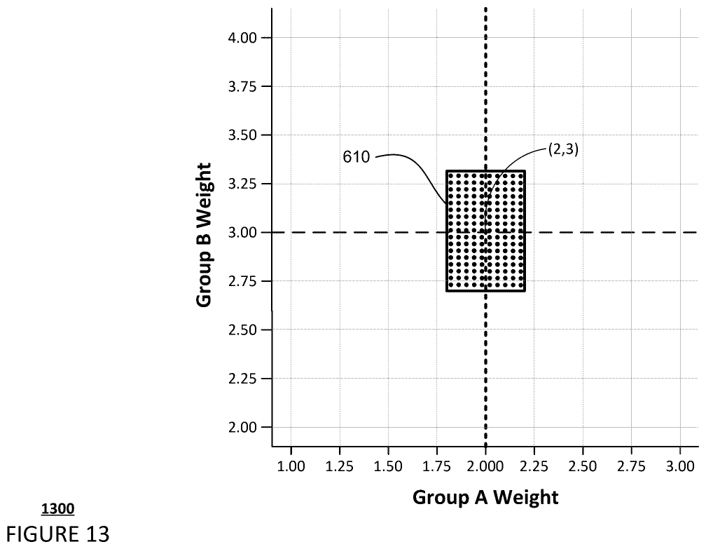

FIG. 13 is an example two-dimensional coordinate plot 1300 which generally corresponds to the example two-dimensional coordinate plots 600 of FIGS. 6 and 1200 of FIG. 12. In the example, as with the example of FIG. 6, box 610 is arranged around the coordinates defining the bounds of the grid search as 10% above (e.g., 2.2 and 3.3) and below (e.g., 1.8 and 2.7) the issuer's preferences (w_{GroupA}=2, w_{GroupB}=3. However, the density of dots within the bounds of the box represents the granularity of the grid search. The increased density of dots in box 610 of FIG. 13 as compared to the density of dots of box 610 of FIG. 12 represents an increase in the granularity of the search. As such, the bounds of these searches are the same, though the number of searches has increased from the example of FIG. 12 to the example of FIG. 13 due to increase in the granularity.

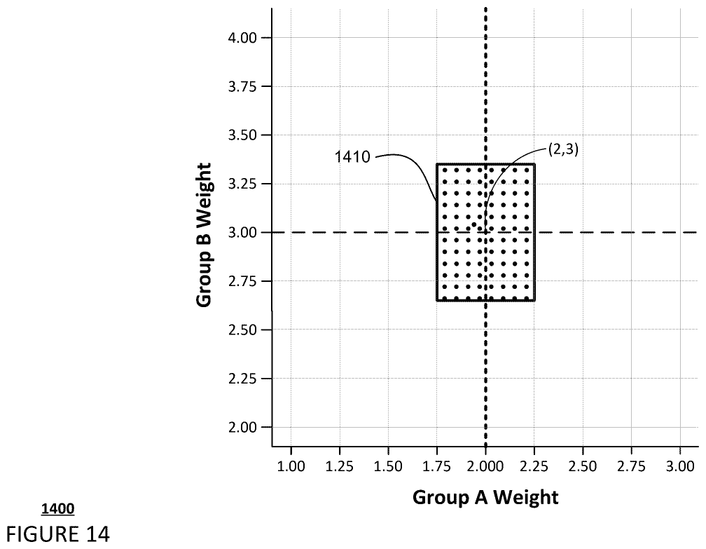

FIG. 14 is an example two-dimensional coordinate plot 1400. In the example, the bounds of box 610 arranged around the coordinates defining the bounds of the grid search have been increased approximately 0.05 in each direction. In this regard, an increase may be an additional fixed amount (as in the example of FIG. 14) or a fixed percentage (e.g., 0.1 or 10% or more or less) of each weight dimension in each direction (positive and negative) or in only particular weight dimensions (e.g., only adjusting for one or more of the weights rather than all of the weights). However, the density of the dots within the bounds of box 1410 is the same as the density of dots within the bounds of box 610 depicted in FIG. 12. As such, the granularities of these searches are the same, though the number of searches has increased from the example of FIG. 12 to the example of FIG. 14 due to the increase in the bounds of the search.

In other instances, with additional time to conduct the search, the allocation system may try various combinations of different granularities in different dimensions (e.g., an asymmetrical search).

In addition, whether or not an optimal solution has been determined for a particular allocation policy in an initial or subsequent search, the inputs and allocation can be saved for comparison and further review. In this regard, an issuer (or a representative of the issuer) can compare dozens of allocation policies, based on different input preferences, selected from billions of potential options, in a matter of seconds or at most a few minutes, giving plenty of time to pick their preference between the deal closing and the markets opening.

Throughout the bookbuild and allocation process, the allocation system may provide notifications and information to the issuer about the process. For instance, the allocation system may provide a notification when the demand for securities is approaching, reaches, and surpasses the number of securities available. This may enable the issuer to better assign weights, groups, etc.

As noted above, while allocations may be done after a bookbuild has closed, some parameters can be “estimated” before this occurs. For instance, if an issuer wants to see in near-real time how an allocation might be performed, the issuer need only provide the aforementioned parameters for the search (number of participants, groups, participants, weights, participant demand, etc.). These may be based on information as it is received by the allocation system or estimates provided by the issuer. In some instances, to get a better understanding of the “result” of an allocation, the issuer may even provide an estimate of the closing price (which may be set by the issuer). Additionally, the number of securities available may sometimes have some flexibility, and so, while an exact number of securities can be provided, the allocation system may also allow the user to view how different numbers of securities will result in different allocations.

The features described herein may provide for real time allocations of securities which maximizes the total allocatable amount, while also respecting any issuer preferences. While there may be unlimited numbers of ways to allocate such securities for a given bookbuild, the features described herein may rapidly identify and converge on an optimal solution and present the issuer with information that provides a transparent understanding of how the process has run. In addition, the allocation system can generate allocations at scale (e.g., to generate allocations for bookbuilds with tens of thousands or even millions of participants) and within very short time frames between market close and market open, above and beyond the capabilities of current institutional allocation tools. Moreover, the allocation system may enable the system to identify nearby optimal solutions when supply is greater than demand which are closest to the issuer's preferences before and after the close of a bookbuild.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method comprising:
identifying, by one or more processors, demand for each of a plurality of participants;
identifying, by the one or more processors, a set of preferences including a weight for each of a plurality of groups of the participants;
identifying, by the one or more processors, a time limit to complete a grid search;
conducting, by the one or more processors, the grid search using the time limit in order to determine weights for an allocation for the participants based on the set of preferences;
generating, by the one or more processors, an allocation for each participant based on the demand for that participant and the determined weights; and
providing, by the one or more processors, the allocations for display to a user.

2. The method of claim 1, wherein the set of preferences includes a guaranteed minimum for at least one of the plurality of groups of participants.

3. The method of claim 2, further comprising:
when an allocation that falls within a tolerance value of one or more initial weights is not found, automatically adjusting the guaranteed minimum; and
conducting a second grid search to determine the determined weights based on the adjusted guaranteed minimum.

4. The method of claim 1, wherein the set of preferences includes a maximum cap for at least one of the plurality of groups of participants.

5. The method of claim 4, further comprising:
when an allocation that falls within a tolerance value of one or more initial weights is not found, automatically adjusting the maximum cap; and
conducting a second grid search to determine the determined weights based on the adjusted maximum cap.

6. The method of claim 1, further comprising, determining whether a total of the demand for each of the participants is greater than a number of securities to be allocated, and wherein the grid search is conducted based on the determination.

7. The method of claim 1, further comprising, determining a number of solutions for the grid search based on the time limit and wherein the grid search is conducted further based on the number of solutions.

8. The method of claim 7, further comprising determining, based on the determined weights for groups of participants, a number of dimensions for the grid search, wherein the number of solutions is further determined based on the number of dimensions.

9. The method of claim 1, further comprising:
determining based on the weights for groups of participants a number of dimensions for the grid search; and
determining a granularity for the grid search using a sensitivity analysis using a sample search in each dimension, wherein the grid search is conducted further based on the determined granularity.

10. The method of claim 9, wherein the grid search is conducted such that the determined granularity is symmetric in each dimension.

11. The method of claim 9, further comprising:
when an allocation that falls within a tolerance value of one or more initial weights is not found, automatically adjusting a granularity of the grid search; and
conducting a second grid search to determine the determined weights based on the adjusted granularity.

12. The method of claim 11, wherein the grid search is conducted such that the determined granularity is not symmetric in each dimension.

13. The method of claim 1, further comprising, determining a number of unallocated securities based on the allocation and a number of securities to be allocated, and wherein the number of unallocated securities is provided for display with the allocation.

14. The method of claim 1, wherein the determined weights are provided for display with the allocations.

15. The method of claim 1, further comprising:
when an allocation that falls within a tolerance value of one or more initial weights is not found, automatically adjusting the time limit for the grid search; and
conducting a second grid search to determine the determined weights.

16. The method of claim 1, further comprising:
when an allocation that falls within a tolerance value of one or more initial weights is not found, automatically adjusting a number of securities to be allocated; and
conducting a second grid search to determine the determined weights based on the adjusted number of securities to be allocated.

17. The method of claim 1, further comprising:
when an allocation that falls within a tolerance value of one or more initial weights is not found, automatically adjusting a granularity of the grid search; and
conducting a second grid search to determine the determined weights based on the adjusted granularity.

18. A system comprising one or more processors configured to:
identify demand for each of a plurality of participants;
identify a set of preferences including a weight for each of a plurality of groups of the participants;
identify a time limit to complete a grid search;
conduct the grid search using the time limit in order to determine weights for an allocation for the participants based on the set of preferences;
generate an allocation for each participant based on the demand for that participant and the determined weights; and
provide the allocations for display to a user.

19. The system of claim 18, wherein the one or more processors are further configured to:
determine, based on the determined weights for groups of participants, a number of dimensions for the grid search; and
determine a granularity for the grid search using a sensitivity analysis using a sample search in each dimension, wherein the grid search is conducted further based on the determined granularity.

20. The system of claim 18, wherein the one or more processors are further configured to:
when an allocation that falls within a tolerance value of one or more initial weights is not found, automatically adjust a granularity of the grid search; and
conduct a second grid search to determine the determined weights based on the adjusted granularity.
